(19) United States
(12) Patent Application Publication
(10) Pub. No.: US 2015/0123001 A1
(43) Pub. Date: May 7, 2015

(54) MEASUREMENT METHOD FOR OBJECT TO BE MEASURED AND MEASUREMENT DEVICE USED THEREOF

(71) Applicant: MURATA MANUFACTURING CO., LTD., Nagaokakyo-Shi (JP)

(72) Inventors: Makoto Hasegawa, Nagaokakyo-shi (JP); Seiji Kamba, Nagaokakyo-shi (JP); Takashi Kondo, Nagaokakyo-shi (JP); Nobuaki Shirai, Nagaokakyo-shi (JP); Toshiki Okada, Nagaokakyo-shi (JP)

(21) Appl. No.: 14/594,635

(22) Filed: Jan. 12, 2015

Related U.S. Application Data
(63) Continuation of application No. PCT/JP2013/069782, filed on Jul. 22, 2013.

(30) Foreign Application Priority Data
Jul. 23, 2012 (JP) 2012-162515

(51) Int. Cl. G01S 17/02

(52) U.S. Cl. CPC G01S 17/026
USPC 250/341.8; 250/338.1

(57) ABSTRACT

A measurement method is disclosed for measuring the presence or absence of an object to be measured or the quantity thereof, and the measurement method includes irradiating an electromagnetic wave on a void-arranged structural body holding the object to be measured, and detecting characteristics of an electromagnetic wave scattered by the void-arranged structural body. The void-arranged structural body has a plurality of void portions penetrating in a direction perpendicular to a primary surface thereof, and at least a part of the object to be measured is held by the void-arranged structural body with carrier particles provided therebetween.

### CROSS REFERENCE TO RELATED APPLICATIONS

The present application is a continuation of PCT/JP2013/069782 filed Jul. 22, 2013, which claims priority to Japanese Patent Application No. 2012-162515, filed Jul. 23, 2012, the entire contents of each of which are incorporated herein by reference.

### FIELD OF THE INVENTION

The present invention relates to a measurement method for an object to be measured and a measurement device used for the measurement method. More particularly, the present invention relates to a measurement method for measuring the presence or absence of an object to be measured or the quantity thereof in which after the object to be measured is held by a void-arranged structural body having void portions, an electromagnetic wave is irradiated on the void-arranged structural body, and the characteristics of an electromagnetic wave scattered thereby are detected, and also relates to a measurement device used for the measurement method described above.

### BACKGROUND OF THE INVENTION

Heretofore, in order to analyze characteristics of substances, there has been used a measurement method for detecting the presence or absence of an object to be measured or the quantity thereof in which after the object to be measured is held by a void-arranged structural body, an electromagnetic wave is irradiated on the void-arranged structural body holding the object to be measured, and the transmission spectrum or the like of the electromagnetic wave is analyzed. In particular, for example, a method may be mentioned in which after a terahertz wave is irradiated on an object to be measured, such as a protein adhered to a metal mesh filter, the transmission spectrum of the terahertz wave is analyzed.

As a related technique of the transmission spectrum analytical method using an electromagnetic wave as described above, Patent Document 1 has disclosed a measurement method in which toward a void-arranged structural body (in particular, a mesh-shaped conductive plate) having void regions which hold an object to be measured, an electromagnetic wave is irradiated in a direction oblique to the direction perpendicular to a primary surface of the void-arranged structural body, and an electromagnetic wave transmitted therethrough is then measured, so that the characteristics of the object to be measured are detected based on the shift of the position of a dip waveform generated in the measured frequency characteristics, the shift being caused by the presence of the object to be measured.

However, a measurement method more superior to the related technique as described above in terms of measurement sensitivity has been desired.

Patent Document 1: Japanese Unexamined Patent Application Publication No. 2008-185552

### SUMMARY OF THE INVENTION

The present invention aims to provide a measurement method more superior to that in the past in terms of measurement sensitivity and a measurement device used for the measurement method.

The present invention provides a measurement method for measuring the presence or absence of an object to be measured or the quantity thereof by irradiating an electromagnetic wave on a void-arranged structural body holding the object to be measured, and detecting the characteristics of an electromagnetic wave scattered by the void-arranged structural body, the void-arranged structural body has a plurality of void portions penetrating in a direction perpendicular to a primary surface thereof, and at least a part of the object to be measured is held by the void-arranged structural body with carrier particles provided therebetween.

The carrier particles are preferably smaller than the void portions.

The at least a part of the object to be measured is preferably held by the void-arranged structural body with the carrier particles provided therebetween in such a way that the object to be measured is adsorbed to the carrier particles, and the carrier particles are then adsorbed to the void-arranged structural body.

The at least a part of the object to be measured is preferably held by the void-arranged structural body with the carrier particles provided therebetween in such a way that the carrier particles are adsorbed to the void-arranged structural body, and the object to be measured is then adsorbed to the carrier particles.

The carrier particles preferably have on surfaces thereof, portions adsorbing to the object to be measured and portions adsorbing to the void-arranged structural body.

The void-arranged structural body preferably has on a surface thereof, portions adsorbing to the carrier particles.

In the carrier particles, the portions adsorbing to the object to be measured are preferably modified by host molecules adsorbing specifically to the object to be measured.

In addition, the present invention provides a measurement device used for the measurement method described above, the measurement device comprises a void-arranged structural body and carrier particles held by the void-arranged structural body, the void-arranged structural body has a plurality of void portions penetrating in a direction perpendicular to a primary surface thereof, and the carrier particles have on surfaces thereof, portions adsorbing to the object to be measured.

According to the present invention, a measurement method more superior to that in the past in terms of measurement sensitivity and a measurement device used for the measurement method can be provided.

### BRIEF DESCRIPTION OF DRAWINGS

FIG. 1 is a schematic view illustrating the outline of a measurement method of the present invention.

FIG. 2 includes schematic views each illustrating the structure of a void-arranged structural body used in the present invention.

FIG. 3 is graph showing a shift amount of a peak frequency in the transmission spectrum of each of Example 1 and Comparative Example 2 based on a peak frequency of the transmission spectrum of Comparative Example 1.

FIG. 4 is graph obtained from the results of Example 2 and Comparative Example 3 to show the comparison in transmittance peak frequency [THz] between the initial value and the value obtained after the adsorption of an object to be measured.

### DETAILED DESCRIPTION OF THE EXEMPLARY EMBODIMENTS

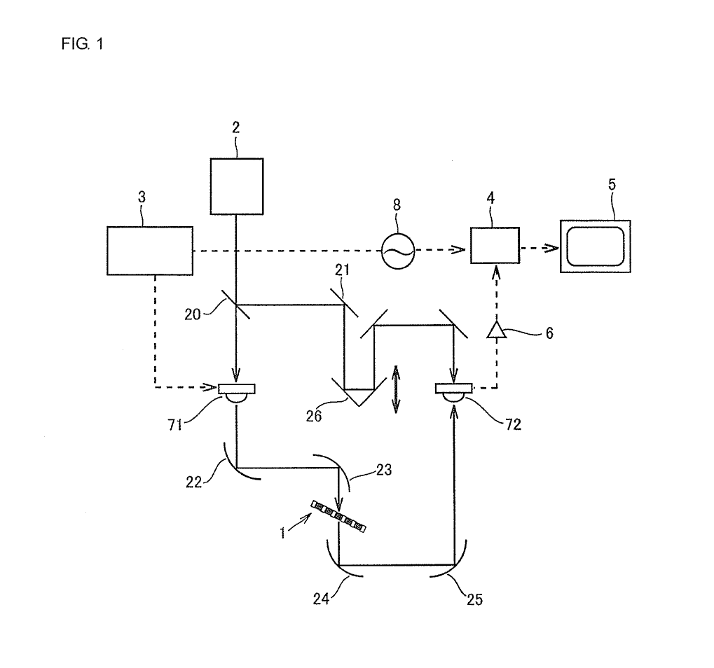

First, the outline of one example of a measurement method of the present invention will be described with reference to FIG. 1. FIG. 1 schematically shows the entire structure of one example of a measurement apparatus used in the measurement method of the present invention. This measurement apparatus uses an electromagnetic wave (such as a terahertz wave having a frequency of 20 GHz to 120 THz) pulse generated by irradiating laser light emitted from a laser 2 (such as a short optical pulse laser) on a semiconductor material.

In the structure shown in FIG. 1, the laser light emitted from the laser 2 is branched into two pathways by a half mirror 20. One branched light is irradiated on an optical conductive element 71 at an electromagnetic wave generation side, and the other branched light is irradiated on an optical conductive element 72 at a receiving side through a time-delay stage 26 by the use of a plurality of mirrors 21 (reference numeral of a mirror having the function similar that thereof is omitted). As the optical conductive elements 71 and 72, there may be used a general optical conductive element in which a dipole antenna having a gap portion in LT-GaAs (low-temperature grown GaAs) is formed. In addition, as the laser 2, a fiber-type laser or a laser using a solid substance such as titanium-sapphire may be used. Furthermore, for the generation and detection of electromagnetic waves, a semiconductor surface may be used without an antenna, or an electro-optic crystal, such as a ZnTe crystal, may be used. In this structure, to the gap portion of the optical conductive element 71 disposed at the generation side, an appropriate bias voltage is applied by a power source 3.

A generated electromagnetic wave is converted into parallel beams by a paraboloidal mirror 22 and is then irradiated on a void-arranged structural body 1 by a paraboloidal mirror 23. A terahertz wave transmitted through the void-arranged structural body 1 is received by the optical conductive element 72 by paraboloidal mirrors 24 and 25. An electromagnetic wave signal received by the optical conductive element 72 is amplified by an amplifier 6 and is then obtained as a time waveform by a lock-in amplifier 4. In addition, after signal processing, such as Fourier transformation, is performed by a PC (personal computer) 5 including calculating means, for example, a transmittance spectrum of the void-arranged structural body 1 is calculated. In order to obtain the time waveform by the lock-in amplifier 4, the bias voltage from the power source 3 applied to the gap of the optical conductive element 71 disposed at the generation side is modulated (amplitude: 5 to 30 V) by a signal of an oscillator 8. Accordingly, synchronous detection is performed, and hence, the S/N ratio can be improved.

The measurement method described above is a method generally called a terahertz time-domain spectroscopy (THz-TDS).

In FIG. 1, the case in which scattering indicates the transmission, that is, the case in which the transmittance of an electromagnetic wave is measured, is shown. The “scattering” in the present invention represents a wide concept including the transmission, which is one form of forward scattering, and the reflection, which is one form of back scattering, and preferably represents the transmission or the reflection. In addition, transmission in the zero-order direction or reflection in the zero-order direction is more preferable.

In addition, in general, when the lattice spacing of a diffraction grating, the incident angle, the diffraction angle, and the wavelength are represented by s, i, θ, and λ, respectively, the spectrum diffracted by the diffraction grating can be represented by the following formula.

s(sin i−sin θ)=nλ (1)

The zero-order of the above “zero-order direction” indicates the case in which n in the above formula (1) is zero. Since s and λ cannot be zero, n=0 can be satisfied only when sin i-sin θ=0 is satisfied. Hence, the above “zero-order direction” indicates the case in which the incident angle is equal to the diffraction angle, that is, the case in which a travelling direction of an electromagnetic wave is not changed.

The electromagnetic wave used in the present invention is not particular limited as long as capable of generating scattering in accordance with the structure of the void-arranged structural body, and any of electrical waves, infrared rays, visible rays, UV rays, X rays, gamma rays, and the like may by used. In addition, although the frequency thereof is also not particularly limited, the frequency is preferably 1 GHz to 1 PHz, and a terahertz wave having a frequency of 20 GHz to 200 THz is more preferable.

As the electromagnetic wave, for example, a linearly polarized electromagnetic wave (linearly polarized wave) having a predetermined polarized wave direction or a non-polarized electromagnetic wave (non-polarized wave) may be used. As the linearly polarized electromagnetic wave, for example, there may be mentioned a terahertz wave generated by an optical rectification effect of an electro-optical crystal, such as ZnTe, using a short optical pulse laser as a power source, visible light emitted from a semiconductor laser, and an electromagnetic wave emitted from an optical conductive antenna. As the non-polarized electromagnetic wave, for example, infrared rays emitted from a high-pressure mercury lamp and a ceramic lamp may be mentioned.

In the present invention, the measurement of the presence or absence of the object to be measured or the measurement of the quantity thereof indicates the measurement to determine the quantity of a compound which is the object to be measured, and for example, there may be mentioned the case in which an extremely low content of the object to be measured in a solution or the like is measured or the case in which the object to be measured is identified.

(Void-Arranged Structural Body)

The void-arranged structural body used in the present invention has a plurality of void portions penetrating in a direction perpendicular to a primary surface thereof. For example, the plurality of void portions are periodically arranged in at least one direction on the primary surface of the void-arranged structural body. However, all the void portions are not required to be periodically arranged, and as long as the effect of the present invention is not adversely degraded, some void portions may be periodically arranged, and the other void portions may be non-periodically arranged.

The void-arranged structural body is preferably a quasi-periodic structural body or a periodic structural body. The quasi-periodic structural body indicates a structural body which has not the translational symmetry but maintains the order in arrangement. As the quasi-periodic structural body, for example, a Fibonacci structure as a one-dimensional quasi-periodic structural body and a Penrose structure as a two-dimensional quasi-periodic structural body may be mentioned. The periodic structural body indicates a structural body which has a spatial symmetry such as the translational symmetry, and in accordance with the dimension of the symmetry, the structural body is classified into a one-dimensional structural body, a two-dimensional structural body, and a three-dimensional structural body. As the one-dimensional structural body, for example, a wire-grid structure and a one-dimensional diffraction grating may be mentioned. As the two-dimensional periodic structural body, for example, a mesh filter and a two-dimensional diffraction grating may be mentioned. Among the periodic structural bodied mentioned above, the two-dimensional structural body is preferably used.

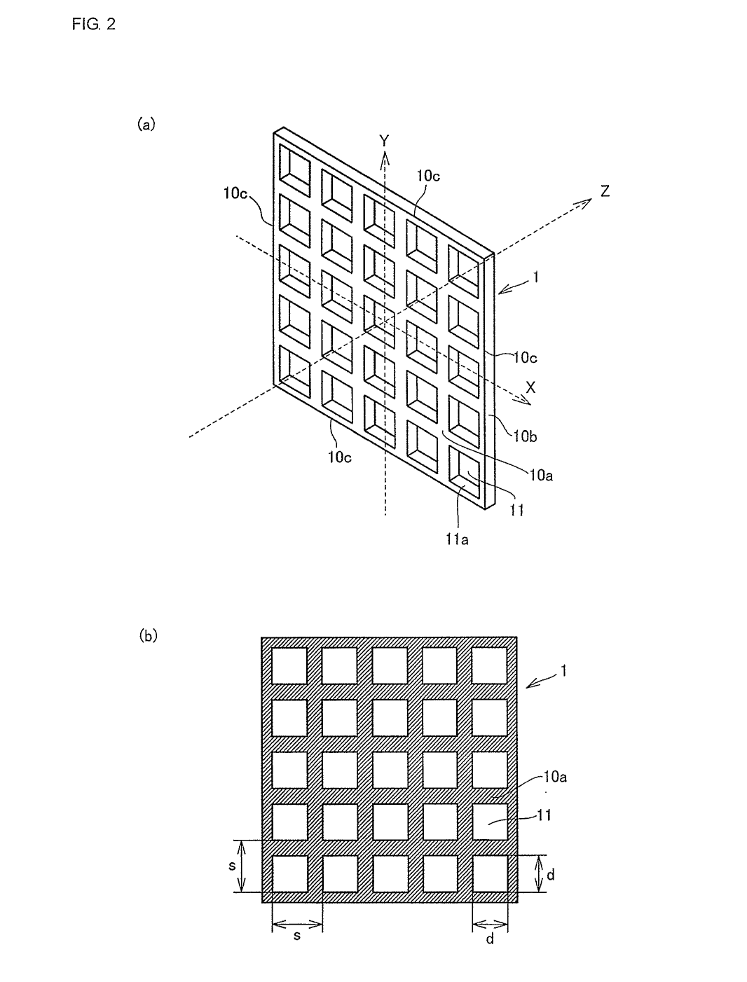

As the two-dimensional periodic structural body, for example, a plate-shaped structural body (lattice-shaped structural body) in which void portions are arranged with predetermined intervals to form a matrix as shown in FIG. 2 may be mentioned. The void-arranged structural body 1 shown in FIG. 2(a) is a plate-shaped structural body in which void portions 11 each having a square shape when viewed from the side of a primary surface 10a of the structural body are provided with identical intervals in two arrangement directions (a longitudinal direction and a lateral direction in the drawing) parallel to the individual sides of the square.

The dimensions and arrangement of the void portions of the void-arranged structural body, the thickness thereof, and the like are not particularly limited and may be appropriately designed in accordance with a measurement method, material characteristics of the void-arranged structural body, the frequency of an electromagnetic wave to be used, and the like.

For example, in the void-arranged structural body 1 in which the void portions are regularly arranged in a longitudinal and a lateral direction as shown in FIG. 2(a), the pore size of the void portion represented by d in FIG. 2(b) is preferably one tenth to 10 times the wavelength of an electromagnetic wave to be used for measurement. By the structure as described above, the intensity of a scattered electromagnetic wave is further enhanced, and the signal is more likely to be detected. As a particular pore size, 0.15 to 150 μm is preferable, and in view of improvement in measurement sensitivity, the pore size is more preferably 0.9 to 9 μm.

In addition, in the void-arranged structural body 1 in which the void portions are regularly arranged in a longitudinal and a lateral direction as shown in FIG. 2(a), the lattice spacing (pitch) of the void portion represented by s in FIG. 2(b) is preferably one tenth to 10 times the wavelength of the electromagnetic wave to be used for measurement. By the structure as described above, the scattering is more likely to occur. As a particular lattice spacing, 0.15 to 150 μm is preferable, and in view of improvement in measurement sensitivity, the lattice spacing is more preferably 1.3 to 13 μm.

In addition, the thickness of the void-arranged structural body is preferably 5 times or less the wavelength of the electromagnetic wave to be used for measurement. By the structure as described above, the intensity of a scattered electromagnetic wave is further enhanced, and the signal is likely to be detected.

The total dimension of the void-arranged structural body is not particularly limited and may be determined, for example, in accordance with the area of a beam spot of an electromagnetic wave to be irradiated.

The void-arranged structural body preferably has on its surface, portions adsorbing to carrier particles which will be described later. Since the carrier particles are adsorbed to the portions described above, at least a part of the object to be measured is held by the void-arranged structural body with the carrier particles provided therebetween.

Although not particularly limited as long as having adsorption characteristics to the carrier particles, the “portions adsorbing to carrier particles” preferably have adsorption characteristics specific to the carrier particles. In the “portions adsorbing to carrier particles”, although a part of the surface of the void-arranged structural body formed from a material non-specifically adsorbing to the object to be measured may be included, in order to obtain a high measurement sensitivity, portions modified with host molecules, which will be described later, are preferably included for the object to be measured.

However, in the present invention, the adsorption of the object to be measured to the void-arranged structural body is not required to be performed only with the carrier particles provided therebetween, and a part of the object to be measured may be directly adsorbed to the surface of the void-arranged structural body without the carrier particles provided therebetween. The reason for this is that when the adsorption to the void-arranged structural body through the carrier particles and the direct adsorption to the void-arranged structural body are used in combination, the adsorption amount of the object to be measured to the void-arranged structural body is increased, and the measurement sensitivity may be improved in some cases.

At least a part of the surface of the void-arranged structural body is preferably formed of a conductor. The at least a part of the surface of the void-arranged structural body 1 indicates a part of the surface selected from the primary surface 10a, a side surface 10b, and a void-portion side surface 11a shown in FIG. 2(a).

In this embodiment, the conductor indicates a substance (material) through which electricity is allowed to pass and includes not only a metal but also a semiconductor. As the metal, for example, a metal capable of bonding to a functional group of a compound having a functional group, such as a hydroxy group, a thiol group, or a carboxy group; a metal having a surface on which a functional group, such as a hydroxy group or an amino group, can be applied; and an alloy thereof may be mentioned. In particular, for example, gold, silver, copper, iron, nickel, chromium, silicon, and germanium may be mentioned; gold, silver copper, nickel, and chromium are preferable; and gold and nickel are more preferable. When gold or nickel is used, if the host molecule particularly has a thiol group (—SH group), it is advantageous since the host molecule can be bonded to the surface of the void-arranged structural body using the thiol group. In addition, when nickel is used, if the host molecule particularly has an alkoxy silane group, it is advantageous since the host molecule can be bonded to the surface of the void-arranged structural body using the alkoxy silane group. In addition, as the semiconductor, for example, a group-IV semiconductor (such as Si or Ge); a compound semiconductor, such as a II-VI-group semiconductor (such as ZnSe, CdS, or ZnO), a III-V-group semiconductor (such as GaAs, InP, or GaN), a IV-group compound semiconductor (such as SiC or SiGe), or a I-III-VI-group semiconductor (such as CuInSe₂); or an organic semiconductor may be mentioned.

(Carrier Particles)

In the measurement method of the present invention, at least a part of the object to be measured is held by the void-arranged structural body with the carrier particles provided therebetween. The “carrier particles” are particulate substance capable of carrying the object to be measured or the like. The shape of the carrier particle is not particularly limited.

The size of the carrier particle is preferably smaller than the size of the void portion. The size of the void portion is the maximum distance between two points on the outline of the shape viewed in a direction of the primary surface of the void-arranged structural body, and for example, when the void-arranged structural body is a structural body having square void portions as shown in FIG. 2, the size of the void portion is the pore size (d in FIG. 2) of the void portion. The size of the carrier particle is the maximum distance between 2 points on the surface thereof, and for example, when the carrier particle has substantially a spherical shape, the size of the carrier particle is the diameter thereof. The reason for this is that when the size of the carrier particle is larger than the size of the void portion, since the void portion is blocked by the carrier particle, desired resonant characteristics of the void-arranged structural body cannot be obtained, and as a result, the measurement cannot be easily carried out.

The size of the carrier particle is more preferably in a range of 1/200 to ½ of the size of the void portion. In particular, the average particle diameter of the carrier particles is preferably in a range of 1/200 to ½ of the average size value of the void portions and preferably 20 nm to 4 μm. In this embodiment, the average particle diameter is the average value of primary particle diameters of the carrier particles obtained by SEM observation.

Although a material of the carrier particles is not particularly limited, for example, a resin material or a metal material may be mentioned. As the resin material, for example, a (meth)acrylic resin, such as a poly(glycidyl methacrylate), or a polystyrene resin may be mentioned. In addition, as a ceramic material, for example, silica or alumina may be mentioned. As the metal material, for example, gold or silver may be mentioned. A material having a high dielectric constant (or refractive index) is preferable.

The carrier particles preferably have on the surfaces thereof, “portions adsorbing to the object to be measured” and “portions adsorbing to the void-arranged structural body”.

In the “portions adsorbing to the object to be measured”, although portions formed of a material non-specifically adsorbing to the object to be measured may be included, in order to obtain a high measurement sensitivity, portions modified by host molecules are preferably included for the object to be measured.

In the “portions adsorbing to the void-arranged structural body”, although portions formed of a material non-specifically adsorbing to the void-arranged structural body may be included, in order to obtain a high measurement sensitivity, portions modified by host molecules are preferably included for the void-arranged structural body.

In addition, in the present invention, the “adsorption” includes, for example, physical adsorption by an intermolecular force (van der Waals force) and chemical adsorption by a chemical bond. As the chemical bond, for example, a covalent bond (such as a covalent bond between a metal and a thiol group), an ion bond, a metal bond, and a hydrogen bond may be mentioned.

The host molecule is a molecule specifically adsorbing to the object to be measured. As the combination between the host molecule and the object to be measured, for example, combinations between an antigen and an antibody, a sugar chain and a protein, a lipid and a protein, a low molecular compound (ligand) and a protein, a protein and a protein, and a single-strand DNA and a single-strand DNA may be mentioned. As particular examples of the host molecule, for example, a molecule having a biotin group, a carboxy group, a sulfo group, an amino group, or the like, and a protein, such as streptavidin, protein A or G, or an antibody, may be mentioned.

### Embodiment 1

In this embodiment, after an object to be measured is adsorbed to carrier particles, the carrier particles are then adsorbed to a void-arranged structural body, so that the object to be measured is held by the void-arranged structural body with the carrier particles provided therebetween.

More particularly, for example, a solution of the carrier particles as described above is mixed with a solution of the object to be measured so that the object to be measured is adsorbed to the carrier particles. Next, the void-arranged structural body is immersed in the above mixed solution so that at least a part of the object to be measured is adsorbed to a surface of the void-arranged structural body with the carrier particles provided therebetween. Subsequently, the void-arranged structural body is recovered from the mixed solution, and a solvent and excessive carrier particles and object to be measured are washed out. The void-arranged structural body thus processed is then dried, and the characteristics of the object to be measured are measured using the measurement apparatus as described above.

In the present invention, as a method to adsorb the object to be measured to the carrier particles and a method to adsorb the carrier particles to the void-arranged structural body, various known methods may be used.

According to this embodiment, compared to a method in which the object to be measured is only adsorbed to the void-arranged structural body, since the object to be measured is held by both the carrier particles and the void-arranged structural body, a label effect by the carrier particles can be obtained. That is, since a material amount adsorbed to the void-arranged structural body is increased as compared to that of the actual object to be measured, the amount of change in characteristics of a scattered electromagnetic wave is increased, and hence, the measurement sensitivity is improved.

In addition, through the step in which the object to be measured is adsorbed to the carrier particles, since the amount of impurities contained in the solution of the object to be measured or the like is reduced, for example, non-specific adsorption of the impurities to the void-arranged structural body is reduced, and as a result, the measurement sensitivity is improved.

In the measurement method of the present invention, based on at least one parameter relating to the characteristics of an electromagnetic wave scattered at the void-arranged structural body obtained as described above, the presence or absence of the object to be measured or the quantity thereof is measured. For example, based on the change in dip waveform generated in the frequency characteristics of an electromagnetic wave forward-scattered (transmitted) by the void-arranged structural body 1, or the change in peak waveform generated in the frequency characteristics of an electromagnetic wave back-scattered (reflected) thereby, the change being caused by the presence of the object to be measured, the presence or absence of the object to be measured or the quantity thereof can be measured.

In this embodiment, the dip waveform is a waveform of a valley type (downward convex) portion which is partially observed in frequency characteristics (such as a transmittance spectrum) of the void-arranged structural body in a frequency range in which the ratio (such as the transmittance of an electromagnetic wave) of a detected electromagnetic wave to an irradiated electromagnetic wave is relatively increased. In addition, the peak waveform is a mountain type (upward convex) waveform which is partially observed in frequency characteristics (such as a reflectance spectrum) of the void-arranged structural body in a frequency range in which the ratio (such as the reflectance of an electromagnetic wave) of a detected electromagnetic wave to an irradiated electromagnetic wave is relatively decreased.

### Embodiment 2

In this embodiment, after carrier particles are adsorbed to a void-arranged structural body, an object to be measured is adsorbed to the carrier particles, so that the object to be measured is held by the void-arranged structural body with the carrier particles provided therebetween. The procedure described above is different from that of the embodiment 1. Since the other points are the same as those of the embodiment 1, description will be omitted.

In order to improve the measurement sensitivity, as one method to increase the absolute amount of the object to be measured held by the void-arranged structural body, an increase in surface area thereof may be conceived. For example, there may be mentioned a method in which porous plating or the like is performed on the surface of the void-arranged structural body to increase the surface area thereof.

In addition, in order to improve the measurement sensitivity for many objects to be measured, the size of the void portions of the void-arranged structural body and the pitch therebetween are preferably decreased. By the structure as described above, the space in which a resonant phenomenon occurs when an electromagnetic wave is irradiated can be decreased, that is, a localized electromagnetic field region can be decreased. Hence, the influence on the change in characteristics of a scattered electromagnetic wave caused by the presence or absence of the object to be measured is increased in the region described above, a smaller (or a smaller amount of) object to be measured can be measured.

However, when the size of the void portion of the void-arranged structural body is decreased (for example, the size of the void portion is set to several micrometers or less), it is technically difficult to form a plating film having finer pores (such as nano-level pores) without causing the influence on the resonant characteristics of the entire void-arranged structural body.

On the other hand, as in the case of this embodiment, when the carrier particles are adsorbed to the surface of the void-arranged structural body, the particle diameter of the carrier particle can be relatively easily decreased. Hence, for example, when the particle diameter of the carrier particle is controlled in the order of nanometers, the size of pores of a pore layer formed by the adsorption of the carrier particles can be controlled in the order of nanometers. Accordingly, a measurement method and a measurement device, each of which has measurement sensitivity superior to that in the past, can be provided. In addition, when the particle diameter distribution of the carrier particles is uniformly controlled, the pore diameters of the pore layer thus obtained can also be uniformly controlled, and a measurement method and a measurement device, each of which has superior reproducibility of resonant characteristics, can be provided.

### EXAMPLES

Hereinafter, although the present invention will be described in more detail with reference to examples, the present invention is not limited thereto.

### Example 1

In this example, as shown in FIG. 2, by the use of carrier particles and a plate-shaped structural body (void-arranged structural body) in which square void portions were periodically arranged in a primary surface direction of the structural body to form a square lattice, a cholera toxin in a living sample was measured.

[Formation of Void-Arranged Structural Body]

The void-arranged structural body used in this example was formed by the following method.

First, after a stainless steel-made conductive plate having a smooth surface of 300 mm square was prepared, a photosensitive thick film photoresist (manufactured by JSR Corp.) was applied on one primary surface of the conductive plate to have a thickness of 5 μm, and the photosensitive resin material was then dried, so that a photosensitive resin layer was formed.

By the use of a photomask corresponding to the void portions 11 periodically arranged in a primary surface 10a direction shown in FIG. 2, portions of the photosensitive thick film photoresist corresponding to the void portions 11 were UV cured. A non-cured portion of the photosensitive thick film photoresist corresponding to a portion (structural body portion) other than the void portions 11 is removed by a rinse liquid, so that the stainless steel-made conductive plate was exposed. To the surface on which patterning was performed by a photolithography as described above, a polymer solution for release purpose was applied and then dried, so that an extremely thin release layer was formed on the exposed portion of the conductive plate.

After the conductive plate thus prepared was placed in a Ni electrolytic plating bath, electricity is allowed to pass therethrough, so that a Ni plating film having a thickness of 1.5 μm was formed only on the release layer formed on the exposed portion of the conductive plate. Subsequently, the cured portion of the photosensitive resin layer remaining on the conductive plate was removed with a solvent, so that the Ni plating film was peeled away from the conductive plate. Electroless Au plating was performed on the surface of the Ni plating film thus obtained, so that a Ni-made void-arranged structural body A covered with Au was obtained.

In the void-arranged structural body A thus obtained, void portions having a pore size of 4 μm were arranged with 6.5-μm pitches, and the thickness was 1.5 μm. The shape of this void-arranged structural body viewed in a primary surface direction thereof was a circle having a diameter of 6 mm.

[Formation of Carrier Particles]

For the formation of the carrier particles, nano particles were used which were formed of a poly(glycidyl methacrylate) as a primary component, which had a diameter of approximately 200 nm, and which had a high dispersibility. The surface of the nano particle was modified with a carboxy group and was able to carry an arbitrary compound having an amino group with this carboxy group provided therebetween. As the nano particles described above, for example, FG beads (COON beads) (manufactured by Tamagawa Seiki Co., Ltd.) may be mentioned.

Furthermore, ganglioside GM1 functioning as a receptor for a cholera toxin (object to be measured) was immobilized on the surface of the nano particle. The immobilization was performed by forming an amino bond between the carboxy group on the surface of the carrier particle and the amino group of lyso-ganglioside GM1 functioning as a receptor for a cholera toxin. As described above, carrier particles (hereinafter referred to as “GM1 immobilized particles” in some cases) were formed from nano particles on which ganglioside GM1 was immobilized, which were formed of a poly(glycidyl methacrylate) as a primary component, which had a diameter of approximately 200 nm, and which had a high dispersibility.

[Surface Treatment of Void-Arranged Structural Body A]

For the surface treatment of the void-arranged structural body A, two types of surface treatments, a cationic adsorption-type and an anionic adsorption-type surface treatment, were performed.

For the cationic adsorption-type surface treatment, first, after immersed in acetone, the void-arranged structural body A was washed with vibration for 10 minutes and was then transferred to another beaker, and drying was performed using a nitrogen gas. Next, in a 5-mL sample tube in which 250 μL of a cation adsorption-type self-assembled film forming agent was charged, the void-arranged structural body A was immersed in a light shielding state at room temperature for 20 hours. Subsequently, after the void-arranged structural body A was recovered and then washed with ethanol, drying was performed using a nitrogen gas, and the void-arranged structural body A was then held by a fixing jig.

In addition, the self-assembled film forming agent was formed by mixing 1 mM of (a) and (b) dissolved in ethanol at an (a)/(b) ratio of 3/1.

### (a): HS—(CH₂)₁₁—OH (Dojindo Laboratories)

### (b): HS—(CH₂)₁₁—SO₃Na (Prochimia)

For the anionic adsorption-type surface treatment, after immersed in acetone, the void-arranged structural body A was washed with vibration for 10 minutes and was then transferred to another beaker, and drying was performed using a nitrogen gas. Next, in a 5-mL sample tube in which 250 mL of an anionic adsorption-type self-assembled film forming agent was charged, the void-arranged structural body A was immersed in a light shielding state at room temperature for 20 hours. Subsequently, after the void-arranged structural body A was recovered and then washed with ethanol, drying was performed using a nitrogen gas, and the void-arranged structural body A was then held by a fixing jig.

In addition, the self-assembled film forming agent was formed by mixing 1 mM of (a) and (b) dissolved in ethanol at an (a)/(b) ratio of 3/1.

### (a): HS—(CH₂)₁₁—OH (Dojindo Laboratories)

### (b): HS—(CH₂)₁₁—NMe₃⁺Cl⁻ (Prochimia)

[Adsorption of Carrier Particles and Object to Be Measured to Void-Arranged Structural Body]

The GM1 immobilized particles in an amount of 100 was sampled in a tube, and 200 μL of a buffer solution A (0.05 M of Tris, 0.2 M of NaCl, and 0.001 M of Na₂EDTA, at a pH of 7.5) was then added in the tube, so that the GM1 immobilized particles were dispersed in the buffer solution. Subsequently, the GM1 immobilized particles were precipitated using a neodymium magnet, and the supernatant was discarded (this operation was hereinafter called magnetic separation). The operation described above was repeatedly performed twice, and washing of the GM1 immobilized particles with the buffer solution A was performed three times in total. Next, after a cholera toxin solution (List Biological Laboratories) at a concentration of 20 μg/mL using the buffer solution A as a solvent was prepared, and the GM1 immobilized particles were dispersed in 400 μL of the cholera toxin solution, and a bonding reaction was performed for 4 hours while stirring was mildly performed at 4° C. Next, the magnetic separation was performed, and the supernatant was discarded. Subsequently, after the GM1 immobilized particles were dispersed in 200 μL of the buffer solution A, the magnetic separation was performed, and the supernatant was discarded. This operation was repeatedly performed twice, and washing of the GM1 immobilized particles with the buffer solution A was performed three times in total. After the washing, the GM1 immobilized particles were dispersed in 200 μL of the buffer solution A and were maintained at 4° C.

Next, after 40 μL of the buffer solution A in which the GM1 immobilized particles were dispersed was placed on the void-arranged structural bodies A processed by the above two types of surface treatments and the void-arranged structural body A processed by no surface treatment, the void-arranged structural bodies were each left at room temperature for 30 minutes. Subsequently, an operation in which after 4 mL of the buffer solution A was added and then vibrated for 5 minutes, the buffer solution A was discarded was performed twice, so that washing of the void-arranged structural body A with the buffer solution A was performed. Subsequently, an operation in which after 4 mL of water was added and then vibrated for 5 minutes, the water was discarded was performed twice, so that washing of the void-arranged structural body A with water was performed twice in total. Next, the void-arranged structural bodies A were each dried for 10 minutes under a reduced pressure.

A transmission spectrum measurement was performed by FT-IR on the void-arranged structural body thus obtained to which the cholera toxin and the GM1 immobilized particles were adsorbed. In this measurement, an electromagnetic wave was irradiated in a direction perpendicular to the primary surface of the void-arranged structural body.

### Comparative Example 1

An operation in which after 4 mL of the buffer solution A was added to the void-arranged structural body A and was then vibrated for 5 minutes, the buffer solution A was discarded was performed twice, so that washing of the void-arranged structural body A with the buffer solution A was performed. Subsequently, an operation in which after 4 mL of water was added and then vibrated for 5 minutes, the water was discarded was performed twice, so that washing of the void-arranged structural body A with water was performed twice in total. Next, the void-arranged structural body A was dried for 10 minutes under a reduced pressure.

A transmission spectrum measurement was performed by FT-IR on the void-arranged structural body A processed as described above (the cholera toxin and the GM1 immobilized particles were not adsorbed thereto).

### Comparative Example 2

Instead of using the buffer solution A in which the particles were dispersed, a cholera toxin (List Biological Laboratories) solution at a concentration of 20 μg/mL itself was placed on the void-arranged structural body to form a sample in which the carrier particles were not contained, and in which a cholera toxin was directly adsorbed to the void-arranged structural body, and subsequently, a transmission spectrum measurement of the sample was performed by FT-IR.

In the transmission spectra obtained by the measurements performed in the above Example 1 and Comparative Examples 1 and 2, the wave number (cm⁻¹) at which the transmittance is maximized is shown in Table 1.

TABLE 1

| | Surface Treatment of | | |
|---|---|---|---|
| | Void-Arranged Structural Body | | |
| | | | Anionic |
| | | Cationic Adsorption | Adsorption |
| | No | Type | Type |
| Example 1 | 6.74 | 13.26 | 27.29 |
| Comparative Example 1 | −0.81 | 5.64 | 1.69 |
| Comparative Example 2 | 2.72 | 9.27 | 8.84 |

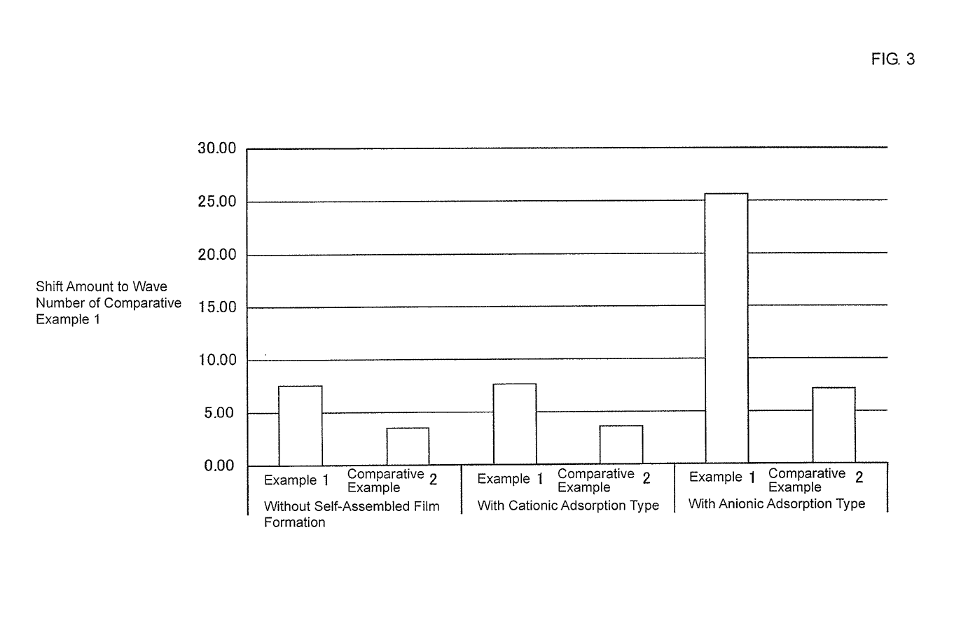

In addition, in Table 2 and by a graph of FIG. 3, the shift amount (cm⁻¹) of the wave number at which the transmittance is maximized in each of Example 1 and Comparative Example 2 is shown based on the wave number at which the transmittance is maximized in Comparative Example 1.

TABLE 2

| | Surface Treatment of | | |
|---|---|---|---|
| | Void-Arranged Structural Body | | |
| | | | Anionic |
| | | Cationic Adsorption | Adsorption |
| | No | Type | Type |
| Example 1 | 7.55 | 7.62 | 25.60 |
| Comparative Example 2 | 3.53 | 3.63 | 7.15 |

The shift amounts of the wave number of Example 1. at which the transmittance is maximized is 7.55 cm⁻¹ when the self-assembled film formation treatment is not performed, is 7.62 cm⁻¹ when the cationic adsorption treatment is performed, and is 25.6 cm⁻¹ when the anionic adsorption treatment is performed. In addition, the wave numbers of Comparative Example 2 at which the transmittance is maximized is 3.53 cm⁻¹ when the self-assembled film formation treatment is not performed, is 3.63 cm⁻¹ when the cationic adsorption treatment is performed, and is 7.15 cm⁻¹ when the anionic adsorption treatment is performed. As described above, it was confirmed that in Example 1 in which the carrier particles were used, the shift amount of the wave number at which the transmittance was maximized was large and the measurement sensitivity was significantly improved as compared to those of Comparative Example 2 in which the carrier particles were not used.

### Example 2

Except that the electroless Au plating was not performed, a void-arranged structural body B similar to that of Example 1 was prepared.

Next, biotin molecules having alkoxysilane terminals and ethanol were prepared, and a biotin solution at a concentration of 500 μg/mL was formed. After the void-arranged structural body B was immersed in the biotin solution for approximately 12 hours, washing was performed with ultra-pure water, so that the void-arranged structural body B was obtained in which the biotin molecules were immobilized to the surface thereof.

Next, after SiO₂ nano particles having an average particle diameter of 100 nm were prepared and then immersed in the biotin solution, the SiO₂ nano particles were dispersed using an ultrasonic washing machine and were then left at room temperature for approximately 12 hours. Subsequently, after the SiO₂ nano particles were separated by a centrifuge separator, the supernatant was discarded, and the solvent was replaced by ultra-pure water. Furthermore, after this centrifuge and replacing operation was repeatedly performed twice, drying was performed, so that biotin-immobilized SiO₂ nano particles were obtained.

Next, by the use of a PBS solution, a streptavidin solution at a concentration of 500 μg/mL was formed. Subsequently, after added to the above streptavidin solution and dispersed therein, the biotin-immobilized SiO₂ nano particles were left at room temperature for approximately 12 hours. Next, by the use of ultra-pure water and a centrifuge separator, washing and drying were performed by a procedure similar to that described above, so that carrier particles formed of streptavidin-immobilized SiO₂ nano particles were obtained.

Next, after the streptavidin-immobilized SiO₂ nano particles were added to a PBS solution and then dispersed therein, the biotin molecule-immobilized void-arranged structural body B was immersed and left in the above solution for 12 hours. Subsequently, after washed with water, the void-arranged structural body B was further immersed and left in a PBS solution of streptavidin at a concentration of 500 [μg/mL] for 12 hours. Next, after the void-arranged structural body B was washed with water and then dried, the transmission characteristics thereof were evaluated as the initial characteristics using FT-IR.

Next, as the object to be measured, a single-strand DNA having a 5′ terminal labeled with biotin (17-mer sequence: GTA AAA CGA CGG CCA GT) was prepared. In addition, the void-arranged structural body B whose initial characteristics were already evaluated was immersed in a PBS solution of the biotin-labeled DNA at a concentration of 500 [μg/mL] and was then left therein for 12 hours. Subsequently, the void-arranged structural body B was washed with water and then dried, so that a sample was obtained in which the biotin-labeled single-strand DNA functioning as the object to be measured was adsorbed to the surfaces of the streptavidin-immobilized SiO₂ nano particles or the surface of the void-arranged structural body with the streptavidin provided therebetween. The transmission characteristics were evaluated using FT-IR, and the change thereof from the initial characteristics was evaluated.

### Comparative Example 3

The void-arranged structural body B provided with biotin molecules immobilized on the surface thereof was immersed and left in a PBS solution of streptavidin at a concentration of 500 [μg/mL] for 12 hours. Subsequently, after the void-arranged structural body B was washed with water and then dried, the transmission characteristics thereof were evaluated as the initial characteristics using FT-IR.

The void-arranged structural body B whose initial characteristics were already evaluated was immersed and left in a PBS solution of a biotin-labeled DNA at a concentration of 500 [μg/mL] for 12 hours. Subsequently, the void-arranged structural body B was washed with water and then dried, so that a sample was obtained in which a biotin-labeled single-strand DNA functioning as the object to be measured was adsorbed to the surface of the void-arranged structural body with the streptavidin provided therebetween. The transmission characteristics of the sample were evaluated using FT-IR, and the change thereof from the initial characteristics was obtained.

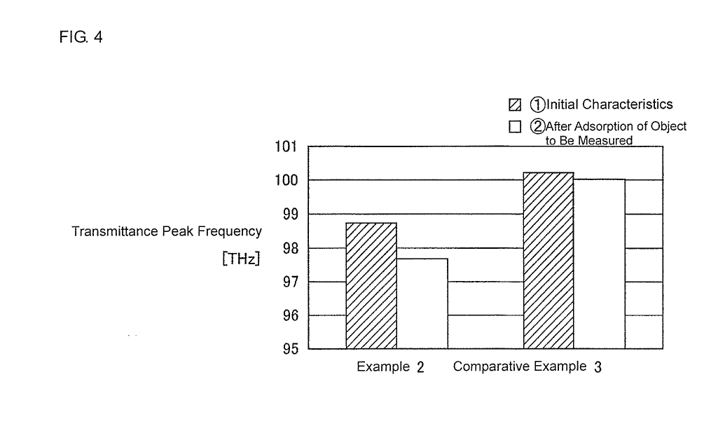

FIG. 4 is a graph obtained from the results of Example 2 and Comparative Example 3 to show the comparison in transmittance peak frequency [THz] between the initial value and the value obtained after the adsorption of the object to be measured. From the results shown in FIG. 4, it was found that in Example 2, the amount of change in transmittance peak frequency after the adsorption of the object to be measured was large and the measurement sensitivity was improved as compared to those of Comparative Example 3.

The embodiments and examples disclosed herein are illustrative in all aspects and should not be considered as being limited. The scope of the present invention is not shown by the above description but is shown by the claims and is intended to include all alterations in the claims and the meaning and scope of equivalents.

### REFERENCE SIGNS LIST

1 void-arranged structural body, 10a primary surface, 10b side surface, 10c periphery, 101 convex portion, 11 void portion, 11a void-portion side surface, 2 laser, 20 half mirror, 21 mirror, 22, 23, 24, 25 paraboloidal mirror, 26 time-delay stage, 3 power source, 4 lock-in amplifier, 5 PC (personal computer), 6 amplifier, 71, 72 optical electrical conductive element, 8 oscillator

1. A measurement method for measuring at least one object, the method comprising:
irradiating an electromagnetic wave on a structural body having a plurality of voids extending in a direction perpendicular to a primary surface of the structural body;
providing carrier particles that hold a portion of the at least one object to the structural body; and
detecting a characteristics of the electromagnetic wave that is scattered when it is irradiated on the structural body.

2. The measuring method according to claim 1, wherein the carrier particles are smaller than the voids of the structural body.

3. The measuring method according to claim 1, further comprising:
causing the at least one object to be adsorbed to the carrier particles; and
causing the carrier particles to be adsorbed to the structural body after the at least one object is adsorbed to the carrier particles.

4. The measuring method according to claim 1, further comprising:
causing the carrier particles to be adsorbed to the structural body; and
causing the at least one object to be adsorbed to the carrier particles after the carrier particles are adsorbed to the structural body.

5. The measuring method according to claim 1, wherein the carrier particles have first surface portions adsorbed to the at least one object and second surface portions adsorbed to the structural body.

6. The measuring method according to claim 1, wherein the structural body comprises a surface configured to adsorb to the carrier particles.

7. The measuring method according to claim 5, further comprising modifying the first surface portions of the carrier particles by host molecules adsorbing to the at least one object.

8. A system for measuring at least one object, the system comprising:
a structural body having a plurality of voids extending in a direction perpendicular to a primary surface of the structural body;
carrier particles that hold a portion of at least one object to the structural body;
a laser configured to irradiate an electromagnetic wave on the structural body; and
an amplifier configured to obtain a waveform related to the electromagnetic wave irradiated on the structural body,
wherein the obtained waveform indicates a quantity of the at least one object.

9. The system for measuring according to claim 8, wherein the carrier particles are smaller than the void of the structural body.

10. The system for measuring according to claim 8, wherein the at least one object is adsorbed to the carrier particles before the carrier particles are adsorbed to the structural body.

11. The system for measuring according to claim 8, wherein the carrier particles are adsorbed to the structural body before the at least one object is adsorbed to the carrier particles.

12. The system for measuring according to claim 8, wherein the carrier particles have first surface portions adsorbed to the at least one object and second surface portions adsorbed to the structural body.

13. The system for measuring according to claim 8, wherein the structural body comprises a surface configured to adsorb to the carrier particles.

14. The system for measuring according to claim 13, wherein the first surface portions of the carrier particles are modified by host molecules adsorbing to the at least one object.

15. The system for measuring according to claim 8, wherein the plurality of voids of the structural body are periodically arranged in at least one direction on the primary surface of the structural body.

16. The system for measuring according to claim 8, wherein the plurality of voids comprise a pore size that is between one tenth and ten times a wavelength of the electromagnetic wave irradiated by the laser.

17. The system for measuring according to claim 8, wherein the plurality of voids comprise a lattice spacing that is between one tenth and ten times a wavelength of the electromagnetic wave irradiated by the laser.

18. The system for measuring according to claim 8, wherein the structural body comprises a thickness that is five times or less a wavelength of the electromagnetic wave irradiated by the laser.
